(19) United States
(12) Patent Application Publication
(10) Pub. No.: US 2024/0385385 A1
(43) Pub. Date: Nov. 21, 2024

(54) OPTICAL CONNECTION COMPONENT AND OPTICAL WIRING

(71) Applicant: SUMITOMO ELECTRIC INDUSTRIES, LTD., Osaka-shi, Osaka (JP)

(72) Inventors: Hajime ARAO, Osaka-shi (JP); Tetsuya NAKANISHI, Osaka-shi (JP)

(73) Assignee: SUMITOMO ELECTRIC INDUSTRIES, LTD., Osaka-shi, Osaka (JP)

(21) Appl. No.: 18/287,499

(22) PCT Filed: May 6, 2022
(86) PCT No.: PCT/JP2022/019607

§ 371 Date: Oct. 19, 2023

(30) Foreign Application Priority Data
May 24, 2021 (JP) 2021-087089

(51) Int. Cl. G02B 6/36

(52) U.S. Cl. CPC G02B 6/3664

(57) ABSTRACT

An optical connection component includes a first surface extending in a second direction intersecting the first direction and in a third direction intersecting both the first direction and the second direction; and a second surface extending in the second direction and the third direction and arranged with the first surface along the first direction. Each of the plurality of cores extends from the first surface along the first direction, and is bent in the third direction to extend to the second surface. The plurality of cores are arranged along the second direction on each of the first surface and the second surface. An order in which the plurality of cores are arranged on the first surface as a whole and an order in which the plurality of cores are arranged on the second surface as a whole are different from each other.

### TECHNICAL FIELD

The present disclosure relates to an optical connection component and an optical wiring.

Priority is claimed on Japanese Patent Application No. 2021-087089, filed on May 24, 2021, the entire content of which is incorporated herein by reference.

### BACKGROUND ART

Patent Literature 1 describes an optical wiring member and an optical wiring structure. The optical wiring member includes a wiring portion and a plurality of optical fiber tape cores extending from the wiring portion. The wiring portion includes a plurality of members having a sheet shape, and a plurality of optical fibers extending from the optical fiber tape cores are inserted between the plurality of members. Each of the plurality of optical fibers includes a first end portion and a second end portion located opposite to the first end portion. The plurality of optical fibers include a plurality of first input/output units aggregated at the first end portions, and second input/output units aggregated at the second end portions. A plurality of intersection portions at which the plurality of optical fibers intersect each other are provided between the first input/output units and the second input/output units. Patent Literature 2 describes an opto-electric hybrid substrate on which a plurality of optical waveguides and a plurality of optical connectors are disposed. The optical waveguides include a plurality of core portions that optically connect a plurality of optical connectors. The plurality of core portions intersect each other on the same plane.

### CITATION LIST

### Patent Literature

Patent Literature 1: International Publication WO 2019/171700
Patent Literature 2: Japanese Unexamined Patent Publication No. 2014-26268

### SUMMARY OF INVENTION

An optical connection component according to the present disclosure includes a plurality of cores that transmit optical signals along a first direction; and a clad having a smaller refractive index than a refractive index of the plurality of cores and integrally surrounding the plurality of cores. The optical connection component includes a first surface extending in a second direction intersecting the first direction and in a third direction intersecting both the first direction and the second direction; and a second surface extending in the second direction and the third direction and arranged with the first surface along the first direction. Each of the plurality of cores extends from the first surface along the first direction, and is bent in the third direction to extend to the second surface. The plurality of cores are arranged along the second direction on each of the first surface and the second surface. An order in which the plurality of cores are arranged on the first surface as a whole and an order in which the plurality of cores are arranged on the second surface as a whole are different from each other.

### BRIEF DESCRIPTION OF DRAWINGS

FIG. 1 is a perspective view showing an optical wiring including an optical connection component according to a first embodiment.

FIG. 2 is a view of the optical connection component according to the first embodiment when viewed along a third direction.

FIG. 3 is a view of the optical connection component according to the first embodiment when viewed along a second direction.

FIG. 4 is a perspective view showing the optical connection component according to the first embodiment.

FIG. 5 is a view for describing a first order and a second order in the optical connection component according to the first embodiment.

FIG. 6 is a view schematically showing the first order and the second order in the optical connection component according to the first embodiment.

FIG. 7 is a view of an optical connection component according to a second embodiment when viewed along the third direction.

FIG. 8 is a view of the optical connection component according to the second embodiment when viewed along the second direction.

FIG. 9 is a perspective view showing the optical connection component according to the second embodiment.

FIG. 10 is a view of an optical connection component according to a third embodiment when viewed along the third direction.

FIG. 11 is a view of the optical connection component according to the third embodiment when viewed along the second direction.

FIG. 12 is a perspective view showing the optical connection component according to the third embodiment.

FIG. 13 is a perspective view showing an optical wiring including an optical connection component according to a fourth embodiment.

FIG. 14 is a view of the optical wiring according to the fourth embodiment when viewed along the second direction.

FIG. 15 is a perspective view showing MT ferrules and optical fiber arrays of the optical wiring according to the fourth embodiment.

### DESCRIPTION OF EMBODIMENTS

As in the optical wiring member described in Patent Literature 1, in a case where routing is performed using optical fibers, when the number of the optical fibers is increased, handling may become complicated. When a plurality of cores intersect each other on the same plane, crosstalk or loss of optical signals may occur at the intersection portions.

An object of the present disclosure is to provide an optical connection component that can be easily handled and that can suppress crosstalk and loss of optical signals.

### Description of Embodiments of Present Disclosure

Initially, embodiments of the present disclosure will be listed and described. (1) An optical connection component according to one embodiment includes a plurality of cores that transmit optical signals along a first direction; and a clad having a smaller refractive index than a refractive index of the plurality of cores and integrally surrounding the plurality of cores. The optical connection component includes a first surface extending in a second direction intersecting the first direction and in a third direction intersecting both the first direction and the second direction; and a second surface extending in the second direction and the third direction and arranged with the first surface along the first direction. Each of the plurality of cores extends from the first surface along the first direction, and is bent in the third direction to extend to the second surface. The plurality of cores are arranged along the second direction on each of the first surface and the second surface. An order in which the plurality of cores are arranged on the first surface as a whole and an order in which the plurality of cores are arranged on the second surface as a whole are different from each other.

In the optical connection component according to one embodiment, the plurality of cores are arranged on each of the first surface and the second surface. Each of the cores extends from the first surface along the first direction, and is bent in the third direction to extend the second surface. The order in which the plurality of cores are arranged on the first surface as a whole and the order in which the plurality of cores are arranged on the second surface as a whole are different from each other. In the optical connection component, the plurality of cores extending from the first surface are bent in the third direction, and the order of the cores is changed between the first surface and the second surface. Therefore, the plurality of cores do not intersect each other on the same plane, so that crosstalk and loss of the optical signals passing through the cores can be suppressed. Then, since the component that changes the order of the cores can be configured as single component, handling can be facilitated.

(2) In (1) described above, the optical connection component described above may further include a third surface connecting the first surface and the second surface and extending in the first direction and the second direction. A first distance from the third surface to the plurality of cores on the first surface and a second distance from the third surface to the plurality of cores on the second surface may be different from each other, and a difference between the first distance and the second distance may be 10 μm or more. In this case, since the length of bending of the cores in the third direction is 10 μm or more, crosstalk and loss of the optical signals can be reliably suppressed.

(3) In (1) or (2) described above, the number of times that each of the plurality of cores is bent in the third direction may be the same for the cores.

(4) In any one of (1) to (3) described above, the plurality of cores may constitute a first group including at least one core among the plurality of cores, and a second group including the cores that do not belong to the first group. An order in which the cores of the first group are arranged on the first surface may be the same as an order in which the cores of the first group are arranged on the second surface, and an order in which the cores of the second group are arranged on the first surface may be the same as an order in which the cores of the second group are arranged on the second surface.

(5) In (4) described above, the number of times that each of the plurality of cores is bent in the third direction may be 1.

(6) In (4) or (5) described above, a rearrangement portion at which an order of the plurality of cores in the second direction is changed may be provided between the first surface and the second surface. A plurality of the cores belonging to the first group may be bent in the third direction between the first surface and the rearrangement portion, and a plurality of the cores belonging to the second group may be bent in the third direction between the rearrangement portion and the second surface.

(7) In any one of (1) to (3) described above, the plurality of cores may constitute a first group including at least one core, a second group including the cores that do not belong to the first group, and a third group including the cores that do not belong to the first group and the second group. An order in which the cores of the first group are arranged on the first surface may be the same as an order in which the cores of the first group are arranged on the second surface. An order in which the cores of the second group are arranged on the first surface may be the same as an order in which the cores of the second group are arranged on the second surface. An order in which the cores of the third group are arranged on the first surface may be the same as an order in which the cores of the third group are arranged on the second surface.

(8) In (7) described above, a plurality of rearrangement portions at which an order of the plurality of cores in the second direction is changed may be provided between the first surface and the second surface. Among the plurality of rearrangement portions, a position of the rearrangement portion at which the cores belonging to the first group are bent in the second direction, a position of the rearrangement portion at which the cores belonging to the second group are bent in the second direction, and a position of the rearrangement portion at which the cores belonging to the third group are bent in the second direction may be different from each other in the first direction.

(9) In (7) described above, a plurality of rearrangement portions at which an order of the plurality of cores in the second direction is changed may be provided between the first surface and the second surface. Among the plurality of rearrangement portions, a position of the rearrangement portion at which the cores belonging to the first group are bent in the second direction, a position of the rearrangement portion at which the cores belonging to the second group are bent in the second direction, and a position of the rearrangement portion at which the cores belonging to the third group are bent in the second direction may be different from each other in the third direction.

(10) An optical wiring according to one embodiment includes the optical connection component according to any one of (1) to (9) described above; and at least one optical fiber array that holds a plurality of optical fibers optically connected to the plurality of cores of the optical connection component. (11) As one aspect of the present embodiment, in (10) described above, the optical wiring may include a plurality of the optical fiber arrays.

In the optical wiring according to the embodiment, handling can be facilitated, and crosstalk and loss of the optical signals can be suppressed.

### Details of Embodiments of Present Disclosure

Specific examples of an optical connection component and an optical wiring according to the present disclosure will be described below with reference to the drawings. Incidentally, it is intended that the present invention is not limited to the following examples and includes all changes implied by the claims and within the scope equivalent to the claims. In the description of the drawings, the same or equivalent elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

### First Embodiment

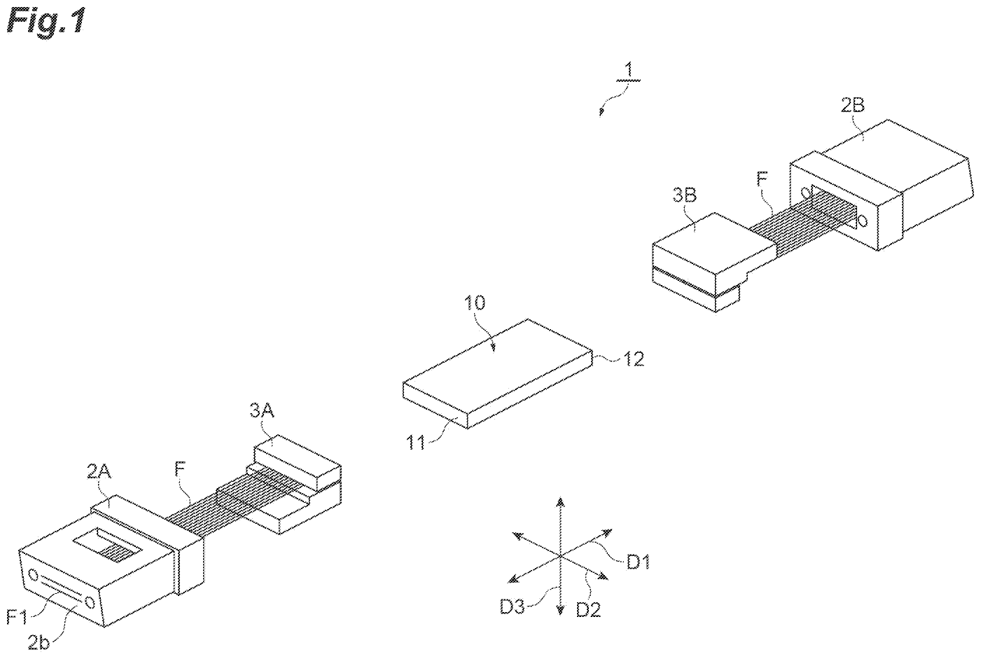

FIG. 1 is a perspective view showing an optical wiring 1 according to a first embodiment. As shown in FIG. 1, the optical wiring 1 includes a first MT ferrule 2A, a second MT ferrule 2B, a first optical fiber array 3A, a second optical fiber array 3B, and an optical connection component 10. For example, the first MT ferrule 2A, the first optical fiber array 3A, the optical connection component 10, the second optical fiber array 3B, and the second MT ferrule 2B are arranged in order along a first direction D1.

The optical connection component 10 transmits optical signals along the first direction D1. In the present embodiment, the first optical fiber array 3A and the second optical fiber array 3B are disposed between the first MT ferrule 2A and the second MT ferrule 2B. The optical connection component 10 is disposed between the first optical fiber array 3A and the second optical fiber array 3B.

The first MT ferrule 2A holds a plurality of single-core fibers F. The single-core fibers F have tip surfaces F1 exposed on an end surface 2b of the first MT ferrule 2A oriented in the first direction D1. In the first MT ferrule 2A, a plurality of the single-core fibers F belong to one of two groups (an upper group and a lower group). In each of the upper group and the lower group, the plurality of single-core fibers F are arranged along a second direction D2 intersecting the first direction D1. The upper group and the lower group are arranged along a third direction D3 intersecting the first direction D1 and the second direction D2.

For example, the second direction D2 is a direction orthogonal to the first direction D1, and the third direction D3 is orthogonal to both the first direction D1 and the second direction D2. The number of the single-core fibers F arranged along the second direction D2 is, for example, 12. In this case, the first MT ferrule 2A is a 24-channel MT ferrule that holds 24 single-core fibers F.

The first optical fiber array 3A holds the plurality of single-core fibers F extending from the first MT ferrule 2A. In the first optical fiber array 3A, the plurality of single-core fibers F are arranged in a row along the second direction D2. The plurality of single-core fibers F extending from the first MT ferrule 2A are converted from being arranged in both second direction D2 and the third direction D3 to being arranged in a row along the second direction D2. However, in FIG. 1, the illustration of conversion of the arrangement state of the single-core fibers F is omitted. For example, in the first optical fiber array 3A, the number of the single-core fibers F arranged along the second direction D2 is 24.

Configurations of the second MT ferrule 2B and the second optical fiber array 3B are the same as configurations of the first MT ferrule 2A and the first optical fiber array 3A, respectively. The second MT ferrule 2B and the second optical fiber array 3B are disposed opposite to the first MT ferrule 2A and the second optical fiber array 3B when viewed from the optical connection component 10. For example, the first MT ferrule 2A and the second MT ferrule 2B are disposed symmetrically with respect to the optical connection component 10. For example, the first optical fiber array 3A and the second optical fiber array 3B are disposed symmetrically with respect to the optical connection component 10.

The optical connection component 10 has a first surface 11 facing the first optical fiber array 3A along the first direction D1, and a second surface 12 facing the second optical fiber array 3B along the first direction D1. The optical connection component 10 has, for example, a rectangular plate shape. Each of the first surface 11 and the second surface 12 extends in both the second direction D2 and the third direction D3. The second surface 12 is arranged with the first surface 11 along the first direction D1.

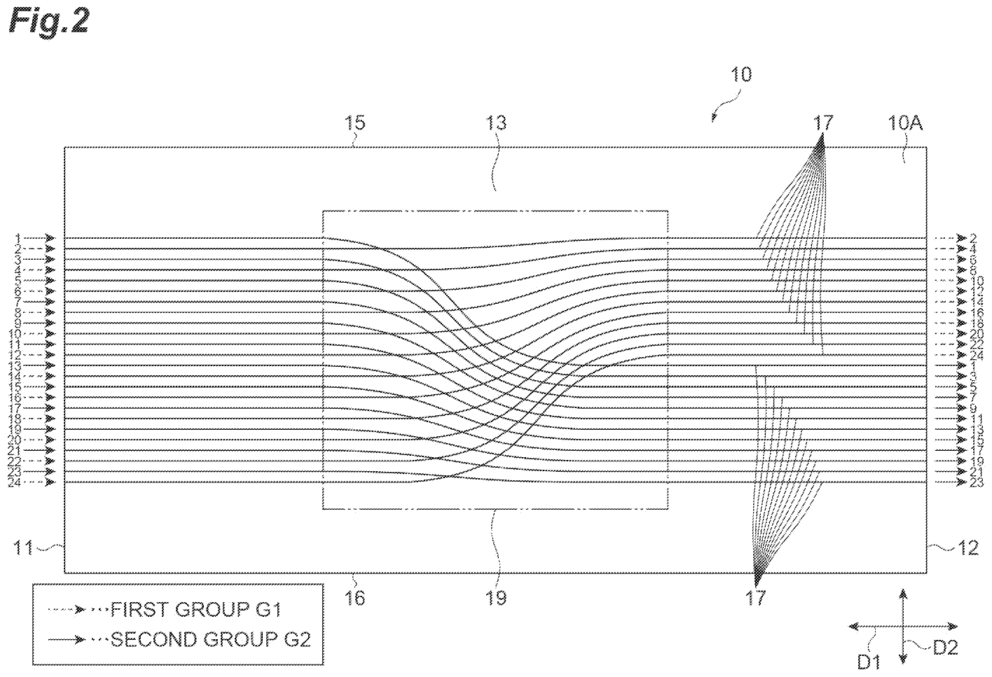

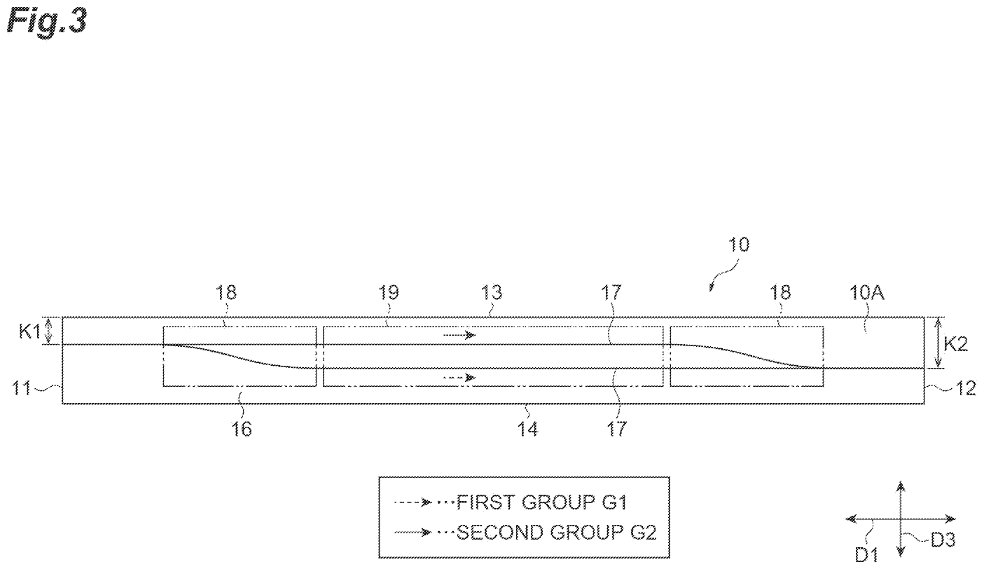

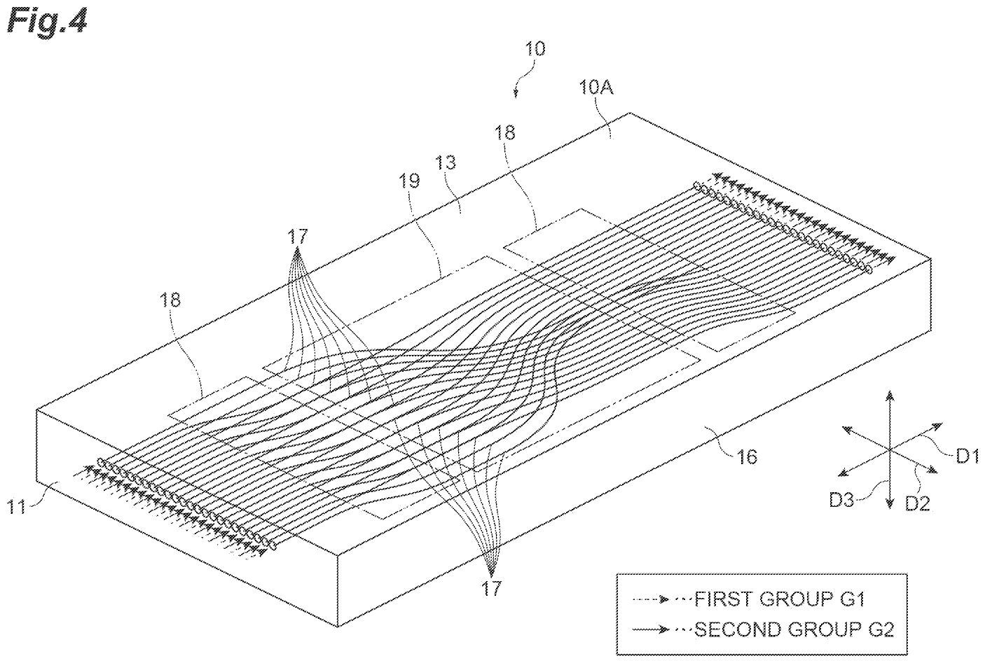

FIG. 2 is a plan view of the optical connection component 10 when the optical connection component 10 is viewed along the third direction D3. FIG. 3 is a side view of the optical connection component 10 when the optical connection component 10 is viewed along the second direction D2. FIG. 4 is a perspective view of the optical connection component 10. As shown in FIGS. 2 to 4, the optical connection component 10 has a third surface 13 extending in the first direction D1 and the second direction D2; a fourth surface 14 facing away from the third surface 13; a fifth surface 15 extending in the first direction D1 and the third direction D3; and a sixth surface 16 facing away from the fifth surface 15, in addition to the first surface 11 and the second surface 12.

The optical connection component 10 includes a clad 10A and a plurality of cores 17 disposed inside the clad 10A and transmitting optical signals along the first direction D1. Incidentally, in the drawings, the cores 17 are indicated by solid lines for easy understanding of the drawings. The plurality of cores 17 and the clad 10A constitute a three-dimensional optical waveguide that transmits optical signals in the cores 17 while being bent in the first direction D1, the second direction D2, and the third direction D3. The cores 17 are fabricated, for example, by irradiation with a femtosecond laser. In the optical connection component 10, the plurality of cores 17 are disposed inside the integral clad 10A. Each of the plurality of cores 17 extends along the first direction D1, and is bent in the second direction D2 and the third direction D3. In the present embodiment, the number of times that the plurality of cores 17 are bent in the third direction D3 is the same for the cores 17. As one example, the number of times that the plurality of cores 17 are bent in the third direction D3 is 1. In this case, the number of times that the cores 17 are bent can be set to a requisite minimum.

The plurality of cores 17 are bent in the third direction D3 inside the optical connection component 10, so that a first distance K1 from the third surface 13 to the plurality of cores 17 on the first surface 11 becomes different from a second distance K2 from the third surface 13 to the plurality of cores 17 on the second surface 12. As one example, the second distance K2 is longer than the first distance K1. A difference between the second distance K2 and the first distance K1 is, for example, 10 μm or more.

The plurality of cores 17 are arranged along the second direction D2 on each of the first surface 11 and the second surface 12. As one example, 24 cores 17 are arranged on a straight line along the second direction D2 on each of the first surface 11 and the second surface 12. The cores 17 on the first surface 11 are optically connected to the respective single-core fibers F of the first optical fiber array 3A. The cores 17 on the second surface 12 are optically connected to the respective single-core fibers F of the second optical fiber array 3B.

The order in which the plurality of cores 17 are arranged on the first surface 11 as a whole and the order in which the plurality of cores 17 are arranged on the second surface 12 as a whole are different from each other. Namely, the order of the plurality of cores 17 is changed between the first surface 11 and the second surface 12. Hereinafter, the order in which the plurality of cores 17 are arranged on the first surface 11 as a whole may be referred to as a first order, and the order in which the plurality of cores 17 are arranged on the second surface 12 as a whole may be referred to as a second order. The optical connection component 10 is a three-dimensional optical waveguide for shuffling that changes the order of the plurality of cores 17 between the first surface 11 and the second surface 12. The term “order” in the embodiment indicates an order in which cores or optical fibers are arranged on a predetermined surface.

The plurality of cores 17 constitute a first group G1 and a second group G2 composed of a plurality of cores 17 that do not belong to the first group G1. The first order in each of the first group G1 and the second group G2 (the order of the cores 17 on the first surface 11) is the same as the second order in each of the first group G1 and the second group G2 (the order of the cores 17 on the second surface 12), respectively. Namely, the order in which the cores 17 of the first group G1 are arranged on the first surface 11 is the same as the order in which the cores 17 of the first group G1 are arranged on the second surface 12. Then, the order in which the cores 17 of the second group G2 are arranged on the first surface 11 is the same as the order in which the cores 17 of the second group G2 are arranged on the second surface 12.

As a specific example, when the first order of the 24 cores 17 arranged on the first surface 11 from a fifth surface 15 side is assumed to be first, second, third, . . . 23rd, and 24th, even-numbered cores 17 belong to the first group G1 and odd-numbered cores 17 belong to the second group G2. In this case, when the first order of the 24 cores 17 is assumed to be first, second, third, . . . , 23rd, and 24th, the second order is changed as follows: second, fourth, . . . , 24th, the first, . . . , 21st, and 23rd. Hereinafter, this may be depicted as the first order being (1, 2, 3, . . . , 23, 24) and the second order being (2, 4, . . . , 24, 1, . . . , 21, 23).

As one example, when n (n is a multiple of 2) cores 17 are provided, a 2k-th (k is a natural number equal to or less than n/2) core 17 on the first surface 11 from the fifth surface 15 is changed to first to n/2-th cores 17 on the second surface 12. Then, a 2k−1-th core 17 on the first surface 11 from the fifth surface 15 is changed to ((n/2)+1)-th to n-th cores 17 on the second surface 12. Namely, the first order on the first surface 11 is (1, 2, 3, . . . , n−1, n), whereas the second order on the second surface 12 is changed to (2, 4, . . . , n, 1, . . . , n−3, n−1).

The optical connection component 10 includes a bending portion 18 at which the plurality of cores 17 are bent in the third direction D3, and a rearrangement portion 19 at which the plurality of cores 17 are bent in the second direction D2 to change the order of the cores 17. In the embodiment, the term “bending portion” indicates a portion from where the bending of the cores 17 in the third direction D3 is started to where the bending ends. The term “rearrangement portion” indicates a portion from where the bending of the cores 17 in the second direction D2 is started to where the bending ends.

The bending portion 18 and the rearrangement portion 19 are provided between the first surface 11 and the second surface 12. In the present embodiment, the rearrangement portion 19 is provided in a region including the center of the optical connection component 10 in the first direction D1. The optical connection component 10 includes a plurality of the bending portions 18. In this case, the position of the bending portion 18 of the first group G1 and the position of the bending portion 18 of the second group G2 are different from each other.

For example, the bending portion 18 of the first group G1 is located between the first surface 11 and the rearrangement portion 19. The bending portion 18 of the second group G2 is located between the rearrangement portion 19 and the second surface 12. Namely, the plurality of cores 17 belonging to the first group G1 are bent in the third direction D3 between the first surface 11 and the rearrangement portion 19, and the plurality of cores 17 belonging to second group G2 are bent in the third direction D3 between the rearrangement portion 19 and the second surface 12. In the present embodiment, the position of the bending portion 18 in the first direction D1 and the position of the rearrangement portion 19 in the first direction D1 are different from each other. Accordingly, the plurality of cores 17 are configured not to come into contact with each other inside the optical connection component 10.

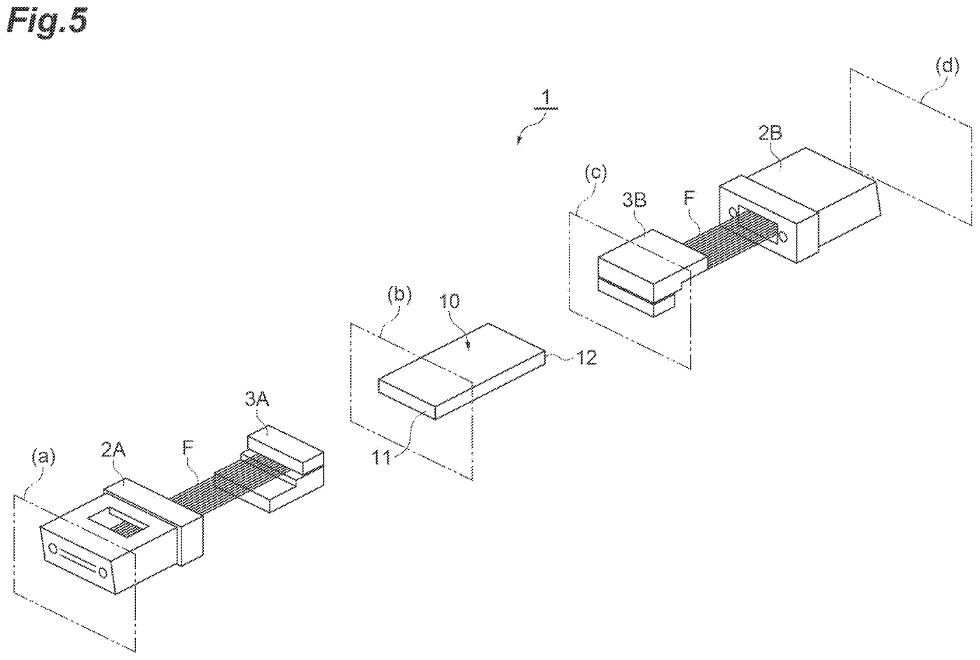

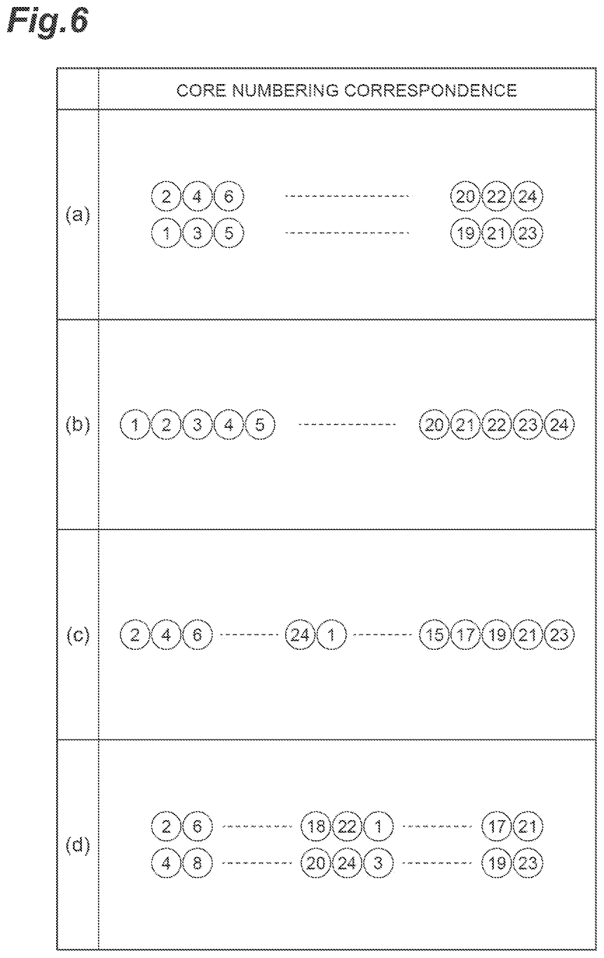

FIGS. 5 and 6 are views for describing a specific example of the order of the single-core fibers F in each of the first MT ferrule 2A, the first optical fiber array 3A, the optical connection component 10, the second optical fiber array 3B, and the second MT ferrule 2B. As described above, when the first order of the plurality of cores 17 on the first surface 11 is (1, 2, 3, . . . , 23, 24) and the second order of the plurality of cores 17 on the second surface 12 is (2, 4, . . . , 24, 1, . . . , 21, 23), the order of the single-core fibers F of the first optical fiber array 3A corresponding to the plurality of respective cores 17 is (1, 2, 3, . . . , 23, 24). Then, the order of the single-core fibers F of the second optical fiber array 3B is (2, 4, . . . , 24, 1, . . . , 21, 23).

Namely, the order (core numbering) of the single-core fibers F on an imaginary cross-section (b) extending in the second direction D2 and the third direction D3 between the first optical fiber array 3A and the optical connection component 10 is (1, 2, 3, . . . , 23, 24). The order (core numbering) of the single-core fibers F on an imaginary cross-section (c) extending in the second direction D2 and the third direction D3 between the optical connection component 10 and the second optical fiber array 3B is (2, 4, . . . , 24, 1, . . . , 21, 23).

The order of the single-core fibers F in the first MT ferrule 2A and the order of the single-core fibers F in the second MT ferrule 2B are different from each other. For example, when the order of the single-core fibers F of the first optical fiber array 3A is (1, 2, 3, . . . , 23, 24), the order of the single-core fibers F in the first MT ferrule 2A (imaginary cross-section (a)) is (2, 4, 6, . . . , 22, 24) at the upper stage, and is (1, 3, 5, . . . , 21, 23) at the lower stage. In this case, the single-core fibers F originally arranged in two stages in the first MT ferrule 2A (imaginary cross-section (a)) are rearranged in a row on the way toward the first optical fiber array 3A.

When the order of the single-core fibers F of the second optical fiber array 3B is (2, 4, 6, . . . , 24, 1, . . . , 21, 23), the order of the single-core fibers F in the second MT ferrule 2B (imaginary cross-section (d)) is (2, 6, . . . , 18, 22, 1, . . . , 17, 21) at the upper stage, and is (4, 8, . . . , 20, 24, 3, . . . , 19, 23) at the lower stage. In this case, the single-core fibers F originally arranged in a row in the second optical fiber array 3B are divided into two stages on the way toward the second MT ferrule 2B to reach the second MT ferrule 2B (imaginary cross-section (d)). In such a manner, in the optical wiring 1 according to the present embodiment including the first MT ferrule 2A, the first optical fiber array 3A, the optical connection component 10, the second optical fiber array 3B, and the second MT ferrule 2B, the order of all the single-core fibers F can be shuffled.

As described above, in the optical connection component 10, the plurality of cores 17 are arranged on each of the first surface 11 and the second surface 12. Each of the cores 17 extends from the first surface 11 along the first direction D1, and is bent in the third direction D3 to extend the second surface 12. The order in which the plurality of cores 17 are arranged on the first surface 11 as a whole (first order) and the order in which the plurality of cores 17 are arranged on the second surface 12 as a whole (second order) are different from each other. Since the plurality of cores 17 do not intersect each other on the same plane, crosstalk and loss of optical signals passing through the cores 17 can be suppressed. Then, since the component that changes the order of the cores 17 can be configured as single component referred to as the optical connection component 10, handling can be facilitated.

### Second Embodiment

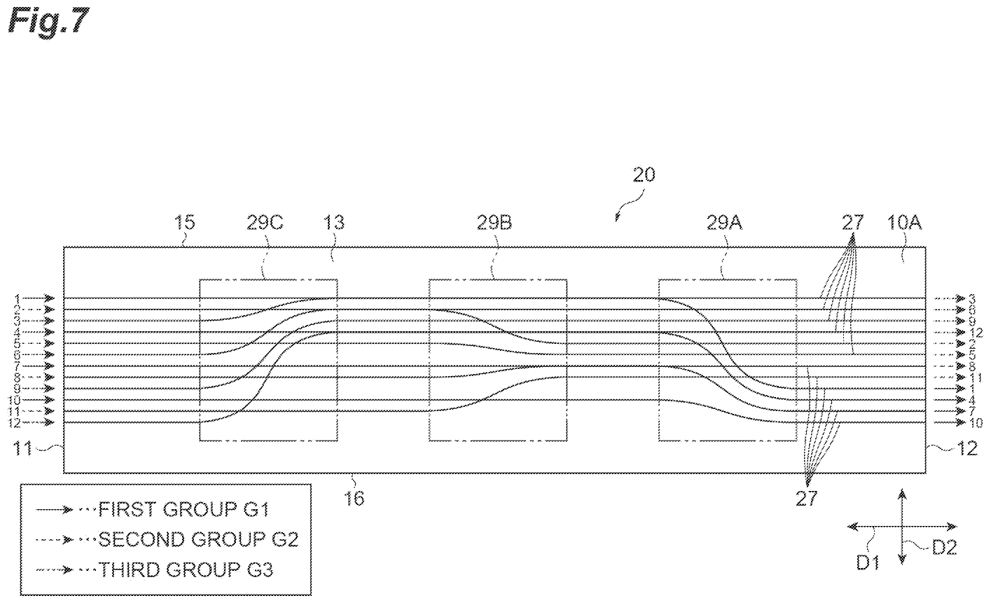

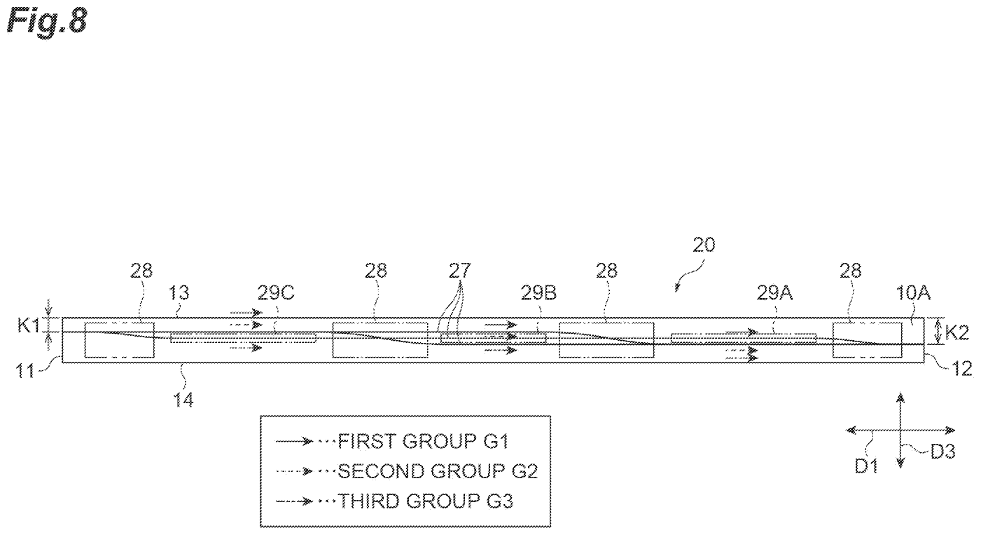

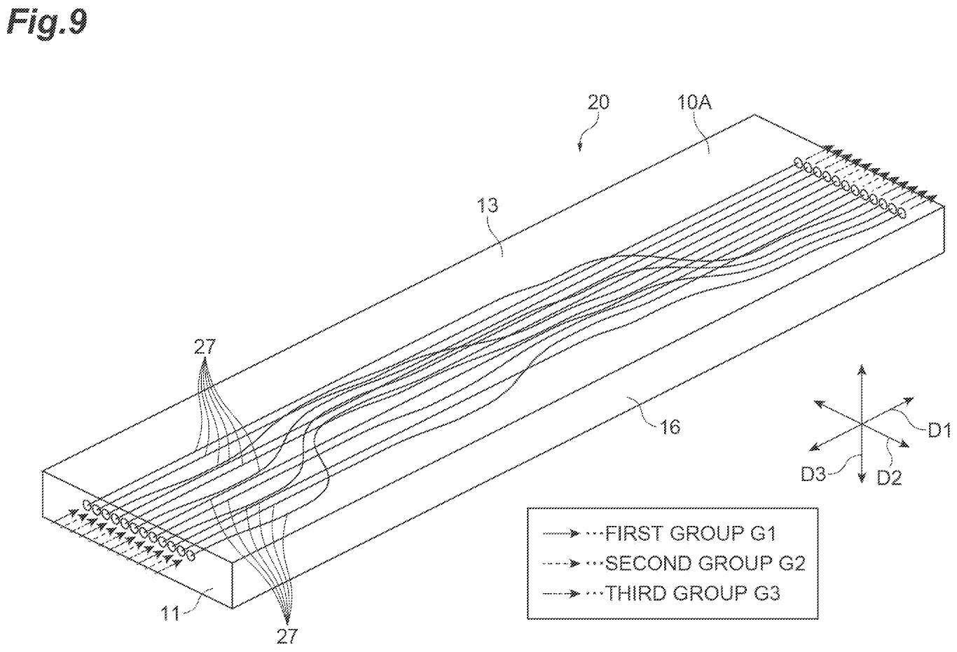

Next, an optical connection component 20 according to a second embodiment will be described with reference to FIGS. 7 to 9. FIG. 7 is a plan view of the optical connection component 20 when viewed along the third direction D3. FIG. 8 is a side view of the optical connection component 20 when viewed along the second direction D2. FIG. 9 is a perspective view showing the optical connection component 20. Since a part of a configuration of the optical connection component 20 overlaps with a part of the configuration of the optical connection component 10, portions overlapping with the configuration of the optical connection component 10 are denoted by the same reference signs, and descriptions thereof will be omitted as appropriate.

As shown in FIGS. 7 to 9, the optical connection component 20 includes the clad 10A and a plurality of cores 27 disposed inside the clad 10A and transmitting optical signals along the first direction D1. For example, the number of times that the plurality of cores 27 are bent in the third direction D3 is 2. For example, 12 cores 27 are arranged on a straight line along the second direction D2 on each of the first surface 11 and the second surface 12.

The plurality of cores 27 constitute the first group G1; the second group G2 composed of a plurality of cores 27 that do not belong to the first group G1; and a third group G3 including the cores 27 that do not belong to the first group G1 and the second group G2. The first order in each of the first group G1, the second group G2, and the third group G3 (the order of the cores 27 on the first surface 11) is the same as the second order in each of the first group G1, the second group G2, and the third group G3 (the order of the cores 27 on the second surface 12), respectively. Namely, the order in which the cores 17 of the first group G1 are arranged on the first surface 11 is the same as the order in which the cores 17 of the first group G1 are arranged on the second surface 12. The order in which the cores 17 of the second group G2 are arranged on the first surface 11 is the same as the order in which the cores 17 of the second group G2 are arranged on the second surface 12. The order in which the cores 17 of the third group G3 are arranged on the first surface 11 is the same as the order in which the cores 17 of the third group G3 are arranged on the second surface 12.

As a specific example, it is assumed that on the first surface 11, a 3m−2-th (m is a natural number) core 27 from the fifth surface 15 side belongs to the first group G1, a 3m−1-th core 27 from the fifth surface 15 belongs to the second group G2, and a 3m-th core 27 from the fifth surface 15 belongs to the third group G3. In this case, the second order on the second surface 12 is changed to (3, 6, 9, 12, 2, 5, 8, 11, 1, 4, 7, 10). As one example, when p (p is a multiple of 3) cores 27 are provided, a 3q-th (q is a natural number equal to or less than p/3) core 27 on the first surface 11 from the fifth surface 15 is changed to first to p/3-th cores 27 on the second surface 12, and a 3q−1-th core 27 on the first surface 11 from the fifth surface 15 is changed to (p/3)+1-th to 2p/3-th cores 27 on the second surface 12. Then, a 3q−2-th core 27 on the first surface 11 from the fifth surface 15 is changed to (2p/3)+1-th to p-th cores 27 on the second surface 12.

The optical connection component 20 includes a plurality of bending portions 28 at which the plurality of cores 27 are bent in the third direction D3, and rearrangement portions 29A, 29B, and 29C at which the plurality of cores 27 are bent in the second direction D2 to change the order of the cores 27. The rearrangement portion 29A indicates a rearrangement portion of the first group G1, the rearrangement portion 29B indicates a rearrangement portion of the second group G2, and the rearrangement portion 29C indicates a rearrangement portion of the third group G3. In the present embodiment, the position of the rearrangement portion 29A of the first group G1, the position of the rearrangement portion 29B of the second group G2, and the position of the rearrangement portion 29B of the third group G3 are different from each other. The positions of the plurality of bending portions 28 are different from each other.

For example, the bending portion 28 is provided between the first surface 11 and the rearrangement portion 29C, between the rearrangement portion 29C and the rearrangement portion 29B, between the rearrangement portion 29B and the rearrangement portion 29A, and between the rearrangement portion 29A and the second surface 12. The distance of each of the cores 27 from the third surface 13 is constant in each of the rearrangement portion 29A, the rearrangement portion 29B, and the rearrangement portion 29C. A distance from the third surface 13 to each of the cores 27 at each of the rearrangement portion 29A, the rearrangement portion 29B, and the rearrangement portion 29C is longer than the first distance K1 from the third surface 13 to the cores 27 on the first surface 11, and is shorter than the second distance K2 from the third surface 13 to the cores 27 on the second surface 12. The rearrangement portion 29C is disposed at a position closer to the first surface 11 than the rearrangement portion 29B, and the rearrangement portion 29A is disposed at a position closer to the second surface 12 than the rearrangement portion 29B.

The cores 27 of the third group G3 extending from the first surface 11 are bent in the third direction D3 at the bending portion 28 to reach the rearrangement portion 29C. The cores 27 of the third group G3 which have reached the rearrangement portion 29C are bent in the second direction D2 to convert the order with respect to the cores 27 of the first group G1 and the cores 27 of the second group G2. The cores 27 of the third group G3 extending from the rearrangement portion 29C toward the second surface 12 reach the bending portion 28 and are further bent in the third direction D3, and then extend toward the second surface 12.

The cores 27 of the second group G2 extending from the first surface 11 extend from the first surface 11 along the first direction D1, pass through the rearrangement portion 29C at a position close to the third surface 13 as it is, and extend along the first direction D1. The cores 27 of the second group G2 passing through the rearrangement portion 29C at the position close to the third surface 13 are bent in the third direction D3 at the bending portion 28 to reach the rearrangement portion 29B. The cores 27 of the second group G2 which have reached the rearrangement portion 29B are bent in the second direction D2 to convert the order with respect to the cores 27 of the first group G1 and the cores 27 of the third group G3. The cores 27 of the second group G2 extending from the rearrangement portion 29B toward the second surface 12 reach the bending portion 28 and are bent in the third direction D3, and then extend toward the second surface 12.

The cores 27 of the first group G1 extending from the first surface 11 extend from the first surface 11 along the first direction D1, pass through the rearrangement portion 29C at a position close to the third surface 13 and the rearrangement portion 29B at a position close to the third surface 13 as it is, and extend along the first direction D1. The cores 27 of the first group G1 passing through the rearrangement portion 29B at the position close to the third surface 13 are bent in the third direction D3 at the bending portion 28 to reach the rearrangement portion 29A. The cores 27 of the first group G1 which have reached the rearrangement portion 29A are bent in the second direction D2 to convert the order with respect to the cores 27 of the second group G2 and the cores 27 of the third group G3. The cores 27 of the first group G1 extending from the rearrangement portion 29A toward the second surface 12 reach the bending portion 28 and are bent in the third direction D3, and then reach the second surface 12.

As described above, the optical connection component 20 includes the rearrangement portion 29A, the rearrangement portion 29B, and the rearrangement portion 29C, at which the plurality of cores 27 are bent in the second direction D2 to change the order of the cores 27, between the first surface 11 and the second surface 12. The positions where the cores 27 are bent in the second direction D2 are different from each other among the first group G1, the second group G2, and the third group G3. Then, while the cores 27 extend from the first surface 11 toward the second surface 12, the cores 27 of the third group G3 are bent in the third direction D3 before the cores 27 of the second group G2, and the cores 27 of the second group G2 are bent in the third direction D3 before the cores 27 of the first group G1. Therefore, the configuration in which the plurality of cores 27 do not come into contact with each other inside the optical connection component 20 is realized.

### Third Embodiment

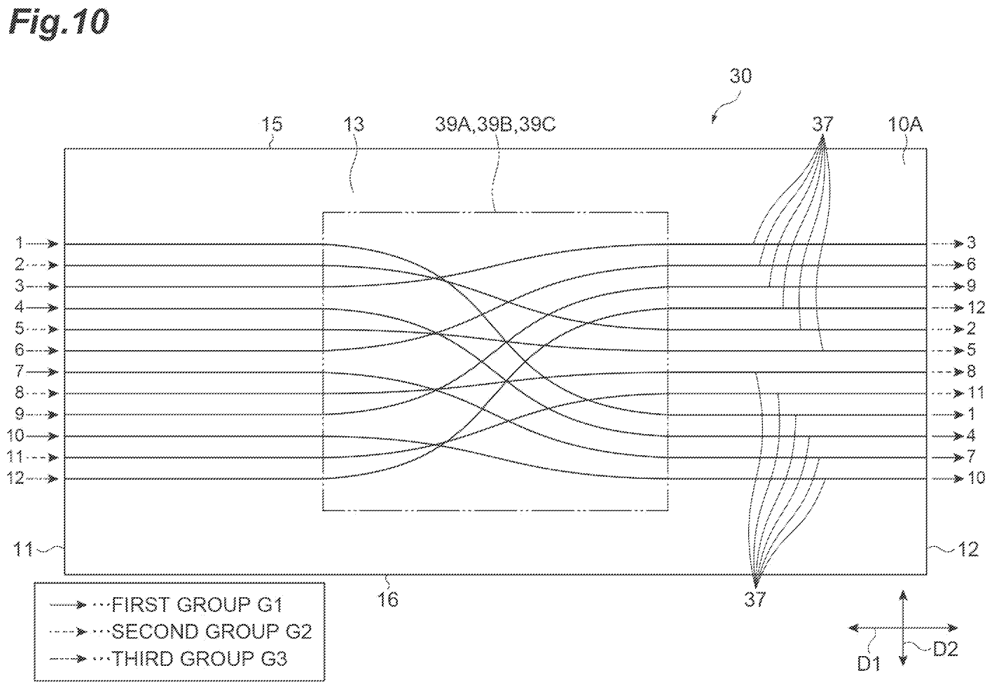

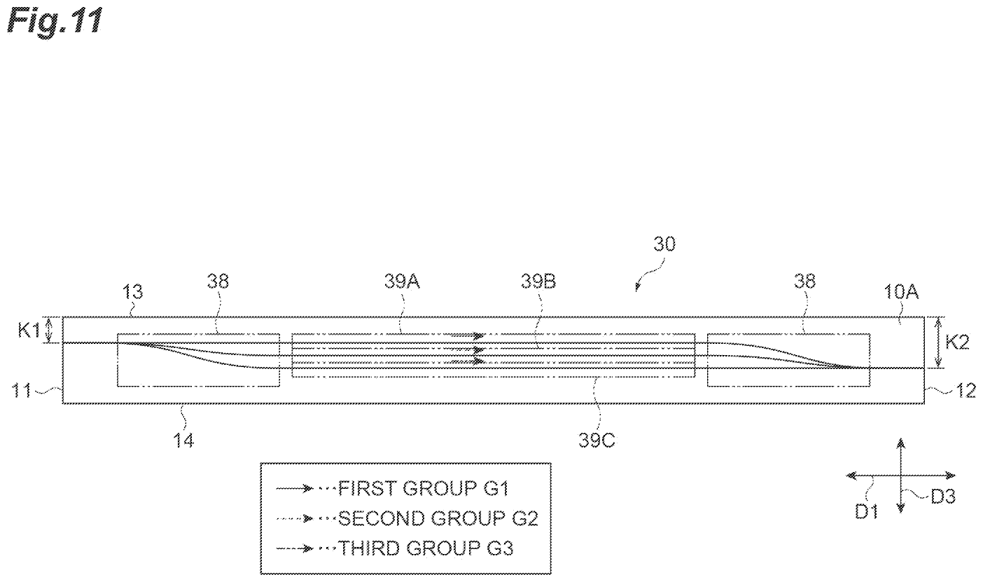

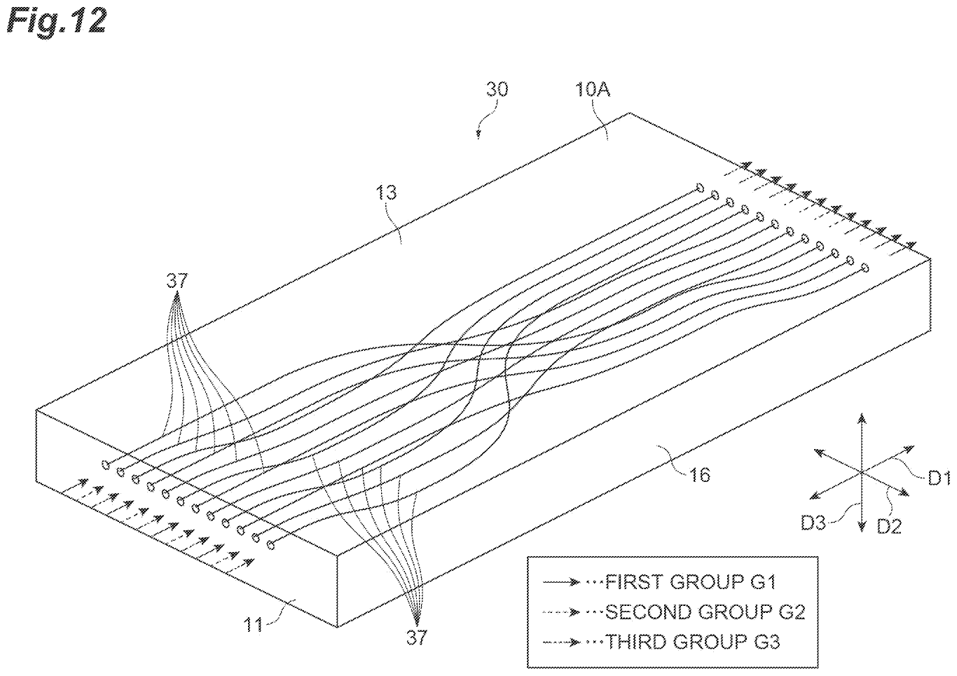

Next, an optical connection component 30 according to a third embodiment will be described with reference to FIGS. 10 to 12. FIG. 10 is a plan view of the optical connection component 30 when viewed along the third direction D3. FIG. 11 is a side view of the optical connection component 30 when viewed along the second direction D2. FIG. 12 is a perspective view showing the optical connection component 30. Hereinafter, portions overlapping with the configuration of each of the embodiments described above are denoted by the same reference signs, and descriptions thereof will be omitted as appropriate.

As shown in FIGS. 10 to 12, the optical connection component 30 includes a plurality of cores 37 disposed inside the clad 10A and transmitting optical signals along the first direction D1. The number of times that the plurality of cores 37 are bent in the third direction D3 is 1 for the first group G1 and the third group G3, and is 2 for the second group G2. In the present embodiment, the number of times that the plurality of cores 37 are bent in the third direction D3 is different between the groups. For example, the number of times is different for each group. The optical connection component 30 includes a plurality of bending portions 38 at which the cores 37 are bent in the third direction D3, and rearrangement portions 39A, 39B, and 39C at which the plurality of cores 37 are bent in the second direction D2 to change the order of the cores 37.

The bending portion 38 is provided between the first surface 11 and the rearrangement portions 39A, 39B, and 39C and between the rearrangement portions 39A, 39B, and 39C and the second surface 12. In the present embodiment, the rearrangement portions 39A, 39B, and 39C are disposed on a plurality of respective planes different from each other. Distances from the third surface 13 to the rearrangement portions 39A, 39B, and 39C are different from each other. For example, the distance from the third surface 13 to the rearrangement portion 39A of the first group G1 is shorter than the distance from the third surface 13 to the rearrangement portion 39B of the second group G2. The distance from the third surface 13 to the rearrangement portion 39B of the second group G2 is shorter than the distance from the third surface 13 to the rearrangement portion 39C of the third group G3. By setting the distance from the third surface 13 to the cores 37 to be different for each group, for example, when the cores 37 are fabricated by performing irradiation with a femtosecond laser along the third direction D3, the fabricated cores 37 can be prevented from interfering with the fabrication of the new cores 37.

The rearrangement portion 39A is disposed at a position closer to the third surface 13 than the rearrangement portion 39B. The rearrangement portion 39B is disposed at a position closer to the third surface 13 than the rearrangement portion 39C. For example, the distance from the third surface 13 to the rearrangement portion 39A is the same as the first distance K1 from the third surface 13 to the cores 37 on the first surface 11. The distance from the third surface 13 to the rearrangement portion 39C is the same as the distance from the third surface 13 to the cores 37 on the second surface 12.

The cores 37 of the third group G3 extending from the first surface 11 are bent in the third direction D3 at the bending portion 38 to reach the rearrangement portion 39C. The cores 37 of the third group G3 which have reached the rearrangement portion 39C are bent in the second direction D2 to convert the order with respect to the cores 37 of the second group G2 and the cores 37 of the first group G1. The cores 37 of the third group G3 extend along the first direction D1 from the rearrangement portion 39C toward the second surface 12.

The cores 37 of the second group G2 extending from the first surface 11 are bent in the third direction D3 at the bending portion 38 to reach the rearrangement portion 39B. The cores 37 of the second group G2 which have reached the rearrangement portion 39B are bent in the second direction D2 to convert the order with respect to the cores 37 of the first group G1 and the cores 37 of the third group G3. The cores 37 of the second group G2 are bent in the third direction D3 at the bending portion 38 again on the way from the rearrangement portion 39B toward the second surface 12, and reach the second surface 12 after being bent in the third direction D3.

The cores 37 of the first group G1 extending from the first surface 11 reach the rearrangement portion 39A without being bent in the third direction D3 at the bending portion 38. The cores 37 of the first group G1 which have reached the rearrangement portion 39A are bent in the second direction D2 to convert the order with respect to the cores 37 of the second group G2 and the cores 37 of the third group G3. The cores 37 of the first group G1 are bent in the third direction D3 at the bending portion 38 on the way from the rearrangement portion 39A toward the second surface 12, and reach the second surface 12 after being bent in the third direction D3.

As described above, in the optical connection component 30, the positions of the rearrangement portions 39A, 39B, and 39C in the third direction D3 are different from each other among the first group G1, the second group G2, and the third group G3. While the cores 37 extend from the first surface 11 toward the second surface 12, the cores 37 of the third group G3 are bent in the third direction D3 at a larger curvature than the cores 37 of the second group G2, and the cores 37 of the first group G1 reach the rearrangement portion 39A without being bent in the third direction D3. Then, while the cores 37 extend from each of the rearrangement portions 39A, 39B, and 39C toward the second surface 12, the cores 37 of the first group G1 are bent in the third direction D3 at a larger curvature than the cores 37 of the second group G2, and the cores 37 of the third group G3 reach the second surface 12 without being bent in the third direction D3. Therefore, the configuration in which the plurality of cores 37 do not come into contact with each other inside the optical connection component 30 is realized.

### Fourth Embodiment

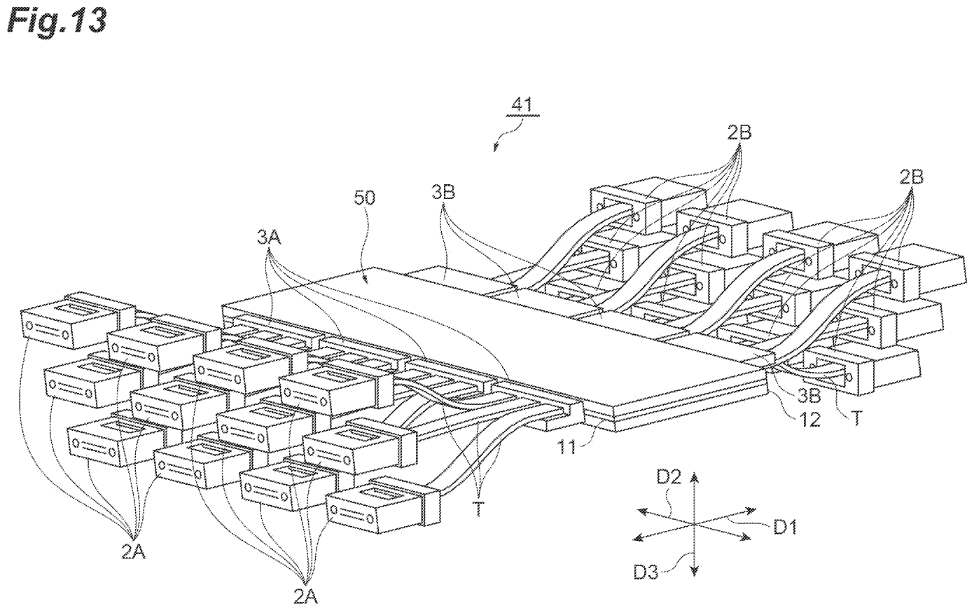

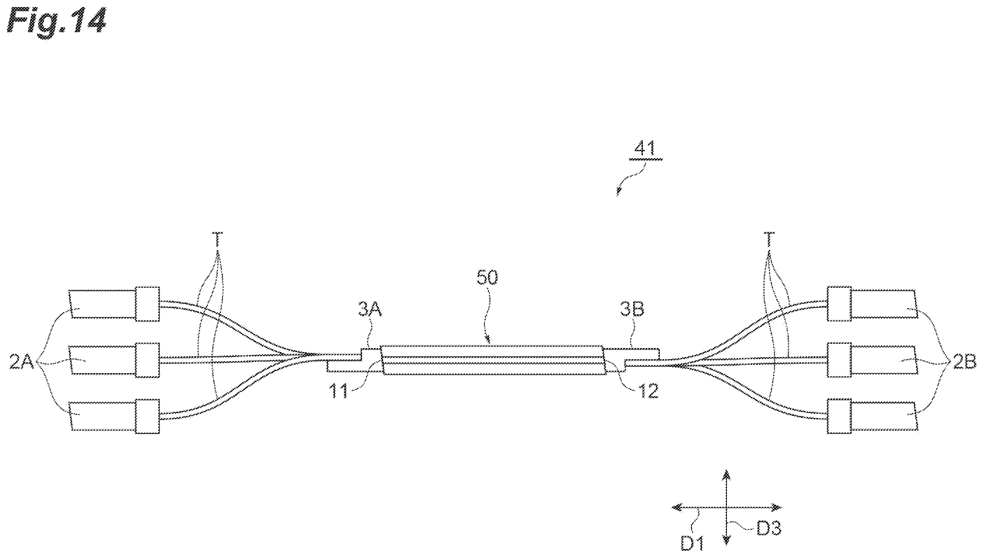

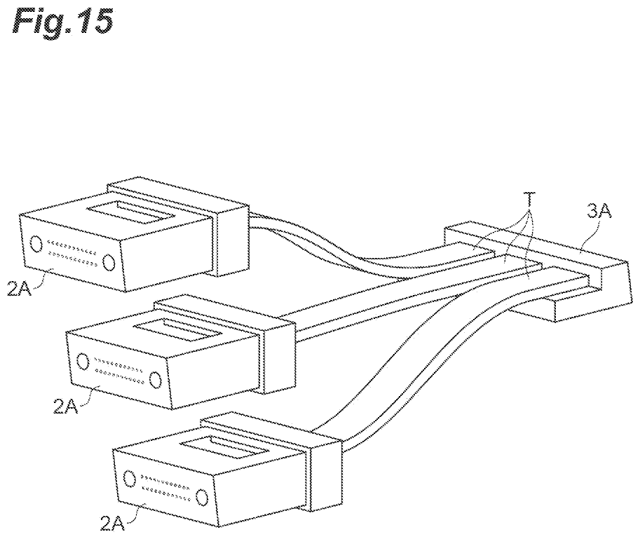

Next, an optical wiring 41 and an optical connection component 50 according to a fourth embodiment will be described with reference to FIGS. 13 to 15. FIG. 13 is a perspective view showing the optical wiring 41 including the optical connection component 50. FIG. 14 is a side view of the optical wiring 41 when viewed along the second direction D2. FIG. 15 is an enlarged perspective view of a portion of the optical wiring 41.

The optical wiring 41 includes a plurality of the first MT ferrules 2A, a plurality of the second MT ferrules 2B, a plurality of the first optical fiber arrays 3A, a plurality of the second optical fiber arrays 3B, and the optical connection component 50. The plurality of first MT ferrules 2A, the plurality of first optical fiber arrays 3A, the optical connection component 50, the plurality of second optical fiber arrays 3B, and the plurality of second MT ferrules 2B are disposed in order along the first direction D1.

Similarly to the optical connection components 10, 20, and 30, the optical connection component 50 transmits optical signals along the first direction D1. The optical connection component 50 has the first surface 11 and the second surface 12. The plurality of first optical fiber arrays 3A are connected to the first surface 11, and the plurality of second optical fiber arrays 3B are connected to the second surface 12. The plurality of first optical fiber arrays 3A and the plurality of second optical fiber arrays 3B are each arranged along the second direction D2.

Tape fibers T each configured by bundling a plurality of the single-core fibers F is provided between the first MT ferrules 2A and the first optical fiber arrays 3A and between the second optical fiber arrays 3B and the second MT ferrules 2B. Namely, each of the first MT ferrules 2A and the first optical fiber arrays 3A, and the second optical fiber arrays 3B and the second MT ferrules 2B are connected via the tape fibers T.

A plurality of the tape fibers T extend from each of the first optical fiber arrays 3A. The first MT ferrules 2A are connected to the plurality of respective tape fibers T extending from each of the first optical fiber arrays 3A. Namely, a plurality of the first MT ferrules 2A are connected to one first optical fiber array 3A. As one example, when the first MT ferrule 2A is a 24-channel MT ferrule, the number of the single-core fibers F held by one tape fiber T is 24.

For example, when the first optical fiber array 3A is a 72-channel optical fiber array, three tape fibers T (72 single-core fibers F) are connected to one first optical fiber array 3A. As one example, in the optical connection component 50, four first optical fiber arrays 3A are connected to the first surface 11, and four second optical fiber arrays 3B are connected to the second surface 12.

For example, the relationship between the second optical fiber arrays 3B and the second MT ferrules 2B is the same as the relationship between the first optical fiber arrays 3A and the first MT ferrules 2A. In the fourth embodiment, the optical wiring 41 including the plurality of first MT ferrules 2A, the plurality of first optical fiber arrays 3A, the optical connection component 50, the plurality of second optical fiber arrays 3B, and the plurality of second MT ferrules 2B has been described above. The same actions and effects as those of the optical wiring according to each of the embodiments described above are obtained from the optical wiring 41 according to the fourth embodiment.

Each of the embodiments has been described above. However, the present disclosure is not limited to the above-described embodiments, and various changes can be made without departing from the concept described in each claim. For example, the number and disposition mode of the cores of the optical connection component can be further changed without departing the above-described concept. In addition, in the above-described embodiments, the optical connection component including two or three groups including a plurality of cores has been described. However, the optical connection component may include four or more groups. In addition, the optical connection component may not include a group.

### REFERENCE SIGNS LIST

1, 41: optical wiring, 2A: first MT ferrule, 2B: second MT ferrule, 2b: end surface, 3A: first optical fiber array, 3B: second optical fiber array, 10, 20, 30, 50: optical connection component, 10A: clad, 11: first surface, 12: second surface, 13: third surface, 14: fourth surface, 15: fifth surface, 16: sixth surface, 17, 27, 37: core, 18, 28, 38: bending portion, 19, 29A, 29B, 29C, 39A, 39B, 39C: rearrangement portion, D1: first direction, D2: second direction, D3: third direction, F: single-core fiber, F1: tip surface, G1: first group, G2: second group, G3: third group, K1: first distance, K2: second distance, T: tape fiber.

1. An optical connection component comprising:
a plurality of cores that transmit optical signals along a first direction;
a clad having a smaller refractive index than a refractive index of the plurality of cores and integrally surrounding the plurality of cores;
a first surface extending in a second direction intersecting the first direction and in a third direction intersecting both the first direction and the second direction; and
a second surface extending in the second direction and the third direction and arranged with the first surface along the first direction,
wherein each of the plurality of cores extends from the first surface along the first direction, and is bent in the third direction to extend to the second surface,
the plurality of cores are arranged along the second direction on each of the first surface and the second surface, and
an order in which the plurality of cores are arranged on the first surface as a whole and an order in which the plurality of cores are arranged on the second surface as a whole are different from each other.

2. The optical connection component according to claim 1, further comprising:
a third surface connecting the first surface and the second surface each other and extending in the first direction and the second direction,
wherein a first distance from the third surface to the plurality of cores on the first surface and a second distance from the third surface to the plurality of cores on the second surface are different from each other, and
a difference between the first distance and the second distance is 10 μm or more.

3. The optical connection component according to claim 1,
wherein the number of times that each of the plurality of cores is bent in the third direction is the same for the cores.

4. The optical connection component according to claim 1,
wherein the plurality of cores constitute a first group including at least one core among the plurality of cores, and a second group including the cores that do not belong to the first group among the plurality of cores,
an order in which the cores of the first group are arranged on the first surface is the same as an order in which the cores of the first group are arranged on the second surface, and
an order in which the cores of the second group are arranged on the first surface is the same as an order in which the cores of the second group are arranged on the second surface.

5. The optical connection component according to claim 4,
wherein the number of times that each of the plurality of cores is bent in the third direction is 1.

6. The optical connection component according to claim 4,
wherein a rearrangement portion at which an order of the plurality of cores in the second direction is changed is provided between the first surface and the second surface,
the plurality of the cores belonging to the first group are bent in the third direction between the first surface and the rearrangement portion, and
the plurality of the cores belonging to the second group are bent in the third direction between the rearrangement portion and the second surface.

7. The optical connection component according to claim 1,
wherein the plurality of cores constitute a first group including at least one core among the plurality of cores, a second group including the cores that do not belong to the first group among the plurality of cores, and a third group including the cores that do not belong to the first group and the second group among the plurality of cores,
an order in which the cores of the first group are arranged on the first surface is the same as an order in which the cores of the first group are arranged on the second surface,
an order in which the cores of the second group are arranged on the first surface is the same as an order in which the cores of the second group are arranged on the second surface, and
an order in which the cores of the third group are arranged on the first surface is the same as an order in which the cores of the third group are arranged on the second surface.

8. The optical connection component according to claim 7,
wherein a plurality of rearrangement portions at which an order of the plurality of cores in the second direction is changed are provided between the first surface and the second surface, and
among the plurality of rearrangement portions, a position of the rearrangement portion at which the cores belonging to the first group are bent in the second direction, a position of the rearrangement portion at which the cores belonging to the second group are bent in the second direction, and a position of the rearrangement portion at which the cores belonging to the third group are bent in the second direction are different from each other in the first direction.

9. The optical connection component according to claim 7,
wherein a plurality of rearrangement portions at which an order of the plurality of cores in the second direction is changed are provided between the first surface and the second surface, and
among the plurality of rearrangement portions, a position of the rearrangement portion at which the cores belonging to the first group are bent in the second direction, a position of the rearrangement portion at which the cores belonging to the second group are bent in the second direction, and a position of the rearrangement portion at which the cores belonging to the third group are bent in the second direction are different from each other in the third direction.

10. An optical wiring comprising:
the optical connection component according to claim 1; and
at least one optical fiber array that holds a plurality of optical fibers optically connected to the plurality of cores of the optical connection component.

11. The optical wiring according to claim 10,
wherein the at least one optical fiber array is a plurality of optical fiber arrays.
